(19) United States
(12) Patent Application Publication
(10) Pub. No.: US 2009/0070952 A1
(43) Pub. Date: Mar. 19, 2009

(54) HEATED WINDSHIELD WIPER

(76) Inventor: Bang Jian PENG, Scarborough (CA)

Correspondence Address: SINORICA, LLC, 528 FALLSGROVE DRIVE, ROCKVILLE, MD, 20850, US

(21) Appl. No.: 12/202,417

(22) Filed: Sep. 1, 2008

Related U.S. Application Data
(60) Provisional application No. 60/993,535, filed on Sep. 13, 2007.
(60) Provisional application No. 60/995,454, filed on Sep. 27, 2007.

(51) Int. Cl. B60S 1/38

(52) U.S. Cl. 15/250.06

(57) ABSTRACT

This invention relates to a windshield wiper that generates heat to soften and melt obstructions like ice and snow for improving the wiping function of the wiper.

### FIELD OF INVENTION

This invention relates to a windshield wiper with functions of being heated to used for removing ice, snow, frost etc. on a vehicle.

### SUMMARY OF THE INVENTION

A windshield wiper (hereafter, alternatively, called “wiper”) is a device to be used on any vehicle or machines for removing anything on the windshield that may obstruct the driver or operator's line of sight. It has been used on various vehicles including automobiles, airplanes, automotives, etc, and has been mainly being made of materials for mechanically wiping off obstructions. A wiper that mechanically wipes off obstructions cannot wipe off heavily buildup obstructions like ice, snow, or frost.

The current invention discloses a windshield wiper that is not only capable to mechanically wipe off obstructions, but also generates heat to soften and melt these obstructions.

### BRIEF DESCRIPTION OF THE DRAWINGS

FIG. 1 shows the structure and elements of the current invention.

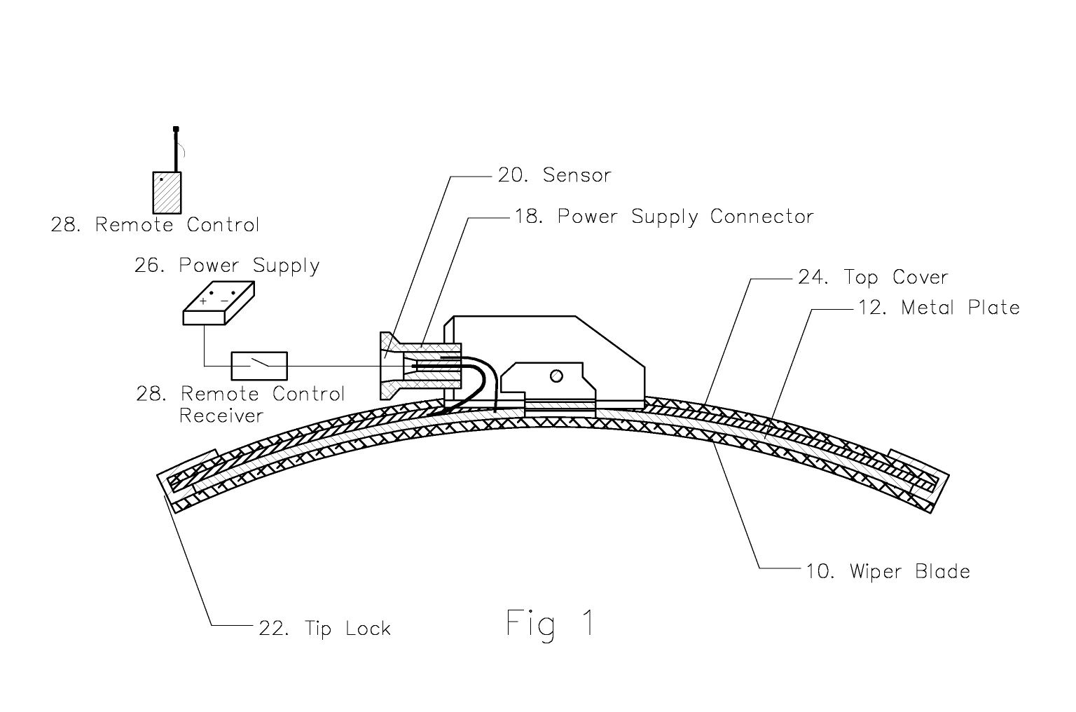

FIG. 2 shows the assembly of metal blades, heat-generating electronics, and solar cells.

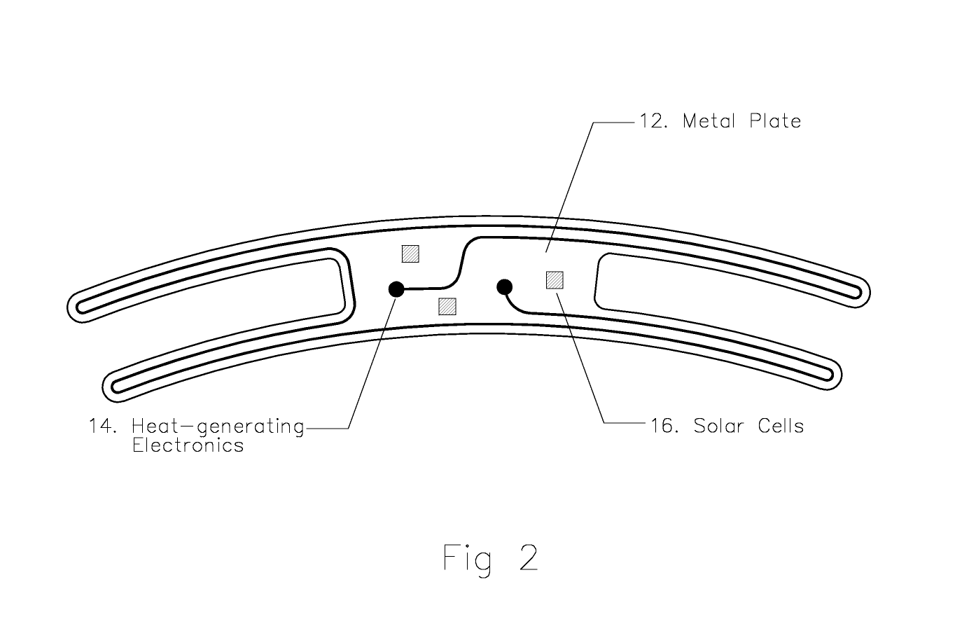

### DETAIL DESCRIPTIONS OF THE INVENTION

### Terminology and Lexicography:

Solar cells: A component or components that generates and stores heat energy in response of receiving solar energy.

The present information is windshield wiper comprises at least one wiper blades 10, one metal plate 12, a plurality of heat-generating electronics 14, at least one top cover 24, a power supply connector 18, a plurality of solar cells 16, and two tip locks 22.

The metal plate 12 is enclosed by and directly attached to the heat-generating electronics 14 and solar cells 16. The assembly of metal blade and heat-generating electronics is enclosed by the at least one wiper blades 10. The wiper blades are made of any material that is capable of conducting and transmitting heat. The assembly of the wiper blades, metal plate, heat-generating electronics, and solar cells is covered by at least one top covers 24. The top covers 24 enclose the assembly of the wiper blades 10, metal plate 12, heat-generating electronics 14, and solar cells 16 so that one side of the assembly directly contacts obstructions and wipes off obstructions with the wiper blades 10.

The metal plate 12 is made of any metal or metal alloy like iron, still, copper, aluminum which transmits and conducts heat.

The power supply connector 18 connects a power supply 26 to the heat-generating electronics. Through the electric current supplied by the power supply, the heat-generating electronic generates heat. By the contact of the heat-generating electronics and the metal plate, the heat generated by the heat-generating electronics is transmitted to and absorbed by the metal plate. The enclosing wiper blades are also heated by the heat from either heat-generating electronics or from the metal plate. The heat-generating electronics includes, but not limited to, electro-resistance sheets, electro-resistance wirings, electro-resistance film. When the power supply is turning ON, the heat-generating electronics starts generating heat. The turning ON or OFF of the power supply for the heat-generating electronics is independent of activation or deactivation of the wiper's wiping function. In other words, when the power supply for the heat-generating electronics is separated from the power supply for the wiper's wiping function, the heat-generation can be independently controlled. On the other hand, the power supply to the heat-generating electronics can only be activated when the wiper's wiping function is activated.

The power supply connector 18 comprises a sensor 20 to detect the environmental temperature for controlling the power supply. When the sensor detects the environmental temperature to be above 3° C (centigrade) or below 40° C. (centigrade), the power supply connector disconnects and stops flowing through the electronic current.

The solar cells 16 absorbs the solar energy and produced heat that consequently transmits to the metal plate and the wiper blades.

Through the heat that is either generated by the heat-generating electronics or the solar cells, the heated wiper blades softens and melts the obstructions like ice and snow.

A remote control 28 can also be used to control a remote control receiver 28 for connecting or disconnecting the connection between the power supply and the heat-generating electronics, in order to control the electric current flow.

The two tip locks 22 are coupled to and enclose the two ends of the assembly of the wiper blades, metal plate, heat-generating electronics, and solar cells respectively for securing the elements of the assembly.

1. A heated windshield wiper comprising:
at least one wiper blades that are made of a material or a combination of materials, and the wiper blades conduct heat;
one metal plate wherein the metal plate is enclosed by the wiper blades;
a plurality of heat-generating electronics wherein the heat-generating electronics generate heat in response of receiving electric current;
the heat-generating electrics enclose and directly attach to the metal plate;
the heat-generating electrics are enclosed by the wiper blades;
the metal plate conducts from and absorbs heat from the heat-generating electronics;
the wiper blades conducts and absorbs heat from the heat-generating electronics and the metal plate;
at least one top cover wherein the top cover encloses a portion of assembly of the metal plate and the heat-generating electronics and the wiper blades, and the assembly exposes a portion of the wiper blades that is not covered by the top cover;
a power supply connector connecting a power supply to the heat-generating electronics;
a plurality of solar cells enclosing the metal plate wherein the solar cells generate heat in response of receiving solar energy;
the solar cells enclose and directly attach to the metal plate;
the solar cells are enclosed by the wiper blades;
the metal plate conducts from and absorbs heat from the solar cells;
the wiper blades conducts and absorbs heat from the solar cells; and
two tip locks couple to and attach to two ends of the assembly to secure elements of the assembly.

2. The heated windshield wiper of claim 1, wherein
the heat-generating electronics are selected from the group consisting of electro-resistance sheets, electro-resistance wirings, and electro-resistance films.

3. The heated windshield wiper of claim 2, wherein
the heat-generating electronics generate heat when the assembly is not in motion.

4. The heated windshield wiper of claim 2, wherein
the heat-generating electronics does not generate heat when the assembly is not in motion.

5. The heated windshield wiper of claim 2, wherein
the power supply is remotely controlled for supplying electric current.

6. The heated windshield wiper of claim 1, wherein
the power supply connector comprises a sensor to detect environmental temperature.

7. The heated windshield wiper of claim 6, wherein
the power supply connector disconnects connection between the power supply and the heat-generating electronics to stop electric current flowing through to the heat-generating electronics when the detected environmental temperature is above 3° C. or below 40° C.
